(19) United States
(12) Patent Application Publication
(10) Pub. No.: US 2017/0246980 A1
(43) Pub. Date: Aug. 31, 2017

(54) SYSTEM FOR TRUCK BED EXTENSION

(71) Applicant: Juan J. Rodriguez, JR., Zephyrhills, FL (US)

(72) Inventor: Juan J. Rodriguez, JR., Zephyrhills, FL (US)

(21) Appl. No.: 15/371,331

(22) Filed: Dec. 7, 2016

Related U.S. Application Data
(60) Provisional application No. 62/299,630, filed on Feb. 25, 2016.

(51) Int. Cl. B60P 3/40; B62D 33/037; B62D 33/027

(52) U.S. Cl. CPC B60P 3/40; B62D 33/0273; B62D 33/037

(57) ABSTRACT

A system for truck bed extension that includes: a truck bed, where the truck bed includes a first tail gate; an extension portion of the truck bed, where the extension portion includes a first position and a second position, wherein the first position is retained in the truck bed behind the first tail gate and the second position extends beyond the first tail gate extending the length of the truck bed; and a second tail gate on the extension portion, where the second tailgate is available when the extension portion is in the second position. The system for truck bed extension may also include a locking mechanism for the extension portion to lock the extension portion in either the first position or second position. The extension portion may extend at more than one length and preferably extends up to 4 feet beyond the first tail gate.

### CROSS REFERENCE TO OTHER APPLICATIONS

This application claims priority to U.S. Provisional Application Ser. No. 62/299,630 filed on Feb. 25, 2016.

### BACKGROUND OF THE INVENTION

Field of Invention

The present invention relates to a system that increases the size of a truck bed as desired by the user.

Description of Related Art

Trucks are one of the most popular vehicles used by consumers. In particular, pickup trucks that include an open truck bed are very popular and allow the users to use the open truck bed for hauling various types of goods and products. However some pickup trucks now have shortened truck bed areas to provide extra passenger seating in the cabin of the truck. This additional seating has caused diminished space in the truck bed. As a result, it would be advantageous to have a system that allows the user to expand the truck bed area as desired. This additional space could provide more adequate room for the truck bed for certain cargo.

### SUMMARY OF THE INVENTION

The present invention relates to a system for truck bed extension that includes: a truck bed, where the truck bed includes a first tail gate; an extension portion of the truck bed, where the extension portion includes a first position and a second position, wherein the first position is retained in the truck bed behind the first tail gate and the second position extends beyond the first tail gate extending the length of the truck bed; and a second tail gate on the extension portion, where the second tailgate is available when the extension portion is in the second position. The system for truck bed extension may also include a locking mechanism for the extension portion to lock the extension portion in either the first position or second position. The extension portion may extend at more than one length and preferably extends up to 4 feet beyond the first tail gate.

### BRIEF DESCRIPTION OF DRAWINGS

FIG. 1 depicts a truck bed in accordance with the present invention.

FIG. 2 depicts an expanded truck bed in accordance with the present invention.

### DETAILED DESCRIPTION

The present invention relates to a system that expands the cargo space of a truck bed by activating an extension portion that extends 2 to 4 feet beyond the existing space of the truck bed. The present invention includes a first tailgate that is lowered to allow for the further extension of a truck bed by the user. The truck bed includes an extendable portion that extends beyond the first tailgate and extends up to 4 feet beyond the initial tailgate barrier. The extendable portion further includes a second tailgate so that the truck bed functions essentially in its original manner with the extended portion in the extended position.

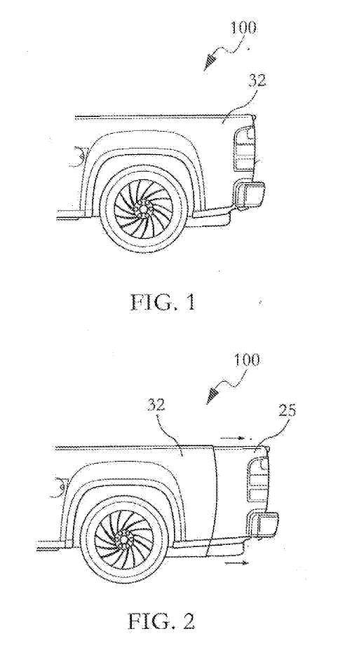

In reference to FIG. 1, a truck bed 100 in accordance with the present invention is depicted. The truck bed 100 includes a truck bed portion 32 and a tailgate 20. This tailgate 20 may be lowered as shown in FIG. 2. Once lowered an extendable portion 25 is extended beyond the first tailgate area. The extended portion 25 may vary in length and provide additional cargo space in the truck bed. This extension of portion 25 may be activated through electronics and mechanism not shown in FIGS. 1 and 2. Upon activation the truck bed 100 may be increased in size up to 4 feet and this extension conversely may be retracted back into the original truck bed 32 creating a unique truck bed system 100 in according with the present invention. The instant invention has been shown and described in what it considers to be the most practical and preferred embodiments. It is recognized, however, that departures may be made there from within the scope of the invention and that obvious modifications will occur to a person skilled in the art.

1. A system for truck bed extension comprising:
a. a truck bed, where the truck bed includes a first position and an extended position; and
an extension portion of the truck bed, where the extension portion is retracted within when the truck bed is in the first position and extended when the truck bed is in an extended position.

2. (canceled)

3. (canceled)

4. (canceled)

5. A method of extending a truck bed comprising the steps of:
a. installing an extension portion to a truck bed;
b. enabling extension and retraction of the extension portion;
c. and
d. extending the extension portion to an extended position from a first position.
